(19) United States
(12) Patent Application Publication
(10) Pub. No.: US 2025/0175632 A1
(43) Pub. Date: May 29, 2025

(54) DECODING METHOD, SYSTEM ON CHIP, AND DECODING DEVICE INCLUDING THE SAME

(71) Applicant: Samsung Electronics Co., Ltd., Suwon-si (KR)

(72) Inventors: Jun-Shik JEON, Suwon-si (KR); Sungho ROH, Suwon-si (KR); Jungyeop YANG, Suwon-si (KR); Jongseong CHOI, Suwon-si (KR)

(73) Assignee: Samsung Electronics Co., Ltd., Suwon-si (KR)

(21) Appl. No.: 18/676,910

(22) Filed: May 29, 2024

(30) Foreign Application Priority Data
Nov. 29, 2023 (KR) 10-2023-0169865

(51) Int. Cl. H04N 19/423; H04N 19/172

(52) U.S. Cl. CPC H04N 19/423; H04N 19/172

(57) ABSTRACT

A decoding method according to some example embodiments includes reading a first input data including information on a first encoded bitstream buffer address from an input data buffer, reading a first DPB data including information on a first DPB address from a DPB data buffer, generating a first decoded picture by decoding a first encoded bitstream stored at the first encoded bitstream buffer address, and storing the first decoded picture at the first DPB address.

### CROSS-REFERENCE TO RELATED APPLICATION

This application claims priority to and the benefit of Korean Patent Application No. 10-2023-0169865 filed in the Korean Intellectual Property Office on Nov. 29, 2023, the entire contents of which are incorporated herein by reference.

### BACKGROUND

### (a) Field

The present disclosure relates to decoding methods, system-on-chips, and a decoding devices including the same.

### (b) Description of Related Art

Electronic devices such as smart phones, tablet PCs, laptop computers, desktop computers, and digital cameras may be equipped with a digital video function. These electronic devices may efficiently transmit, receive, encode, decode, and/or store digital video information by implementing a video compression technology.

As the demand for high-definition videos increases, electronic devices need to process a large amount of digital video information. Since encoding or decoding digital video information requires a significant amount of time, research is being conducted to reduce latency.

### SUMMARY

The present disclosure is to provide decoding methods, system-on-chips, and decoding devices including the same, capable of storing a plurality of decoded pictures with limited or no interruption.

The present disclosure is to provide decoding methods, system-on-chips, and decoding devices including the same, having reduced decoding latency.

A decoding method according to some example embodiments for addressing the technical challenges includes reading a first input data including information on a first encoded bitstream buffer address from an input data buffer, reading a first DPB data including information on a first DPB address from a DPB data buffer, generating a first decoded picture by decoding a first encoded bitstream stored at the first encoded bitstream buffer address, and storing the first decoded picture at the first DPB address.

A system-on-chip according to some example embodiments includes a processor configured to write a first input data including information on a first encoded bitstream buffer address in an input data buffer, and write a first DPB data including information on a first DPB address in a DPB data buffer, and a codec configured to read the first input data from the input data buffer, read the first DPB data from the DPB data buffer, generate a first decoded picture by decoding a first encoded bitstream stored at the first encoded bitstream buffer address, and store the first decoded picture at the first DPB address.

A decoding device according to some example embodiments includes a working memory that includes an encoded bitstream buffer configured to store a plurality of encoded bitstreams, an input data buffer configured to store a plurality of input data including information on a plurality of encoded bitstream buffer addresses, a decoded picture buffer (DPB) configured to store a plurality of decoded pictures, and a DPB data buffer configured to store a plurality of DPB data including information on a plurality of DPB addresses, and a system-on-chip configured to read a first input data including information on a first encoded bitstream buffer address from the input data buffer, read a first DPB data including information on a first DPB address from the DPB data buffer, read a first encoded bitstream stored at the first encoded bitstream buffer address, generate a first decoded picture by decoding the first encoded bitstream, and store the first decoded picture at the first DPB address of the decoded picture buffer.

### BRIEF DESCRIPTION OF THE DRAWINGS

FIG. 1 is a block diagram of a video coding device including a system-on-chip according to some example embodiments.

FIG. 2 is a block diagram illustrating a codec according to some example embodiments.

FIG. 3 is a diagram illustrating a working memory according to a comparative example.

FIG. 4 is a diagram illustrating an input data buffer of the working memory according to the comparative example.

FIG. 5 is a flow chart illustrating a decoding method of the comparative example.

FIG. 6 is a diagram illustrating a working memory according to some example embodiments.

FIG. 7 is a diagram illustrating a decoded picture buffer (DPB) data buffer of a working memory according to some example embodiments.

FIG. 8 is a flow chart illustrating a decoding method according to some example embodiments.

FIG. 9 is a flow chart illustrating a method of using DPB data in the DPB data buffer according to some example embodiments.

FIG. 10 is a diagram illustrating a DPB and a DPB data buffer according to some example embodiments.

FIG. 11 is a flow chart illustrating a method of updating DPB data in the DPB data buffer according to some example embodiments.

FIG. 12 is a diagram illustrating a DPB and a DPB data buffer according to some example embodiments.

FIG. 13 is a flow chart illustrating a decoding method according to some example embodiments.

### DETAILED DESCRIPTION

In the following detailed description, only some example embodiments of the present inventions have been shown and described, simply by way of illustration. As those skilled in the art would realize, the described example embodiments may be modified in various different ways, all without departing from the spirit or scope of the present inventions.

Accordingly, the drawings and description are to be regarded as illustrative in nature and not restrictive. Like reference numerals designate like elements throughout the specification. In the flow charts described with reference to the drawings, the order of operations may be changed, and several operations may be combined, and an operation may be divided, and some operations may not be performed.

Further, expressions written in the singular forms can be comprehended as the singular forms or plural forms unless clear expressions such as “a”, “an”, or “single” are used. Terms including an ordinal number, such as first and second, are used for describing various constituent elements, but the constituent elements are not limited by the terms. The terms are used only to discriminate one constituent element from other constituent elements.

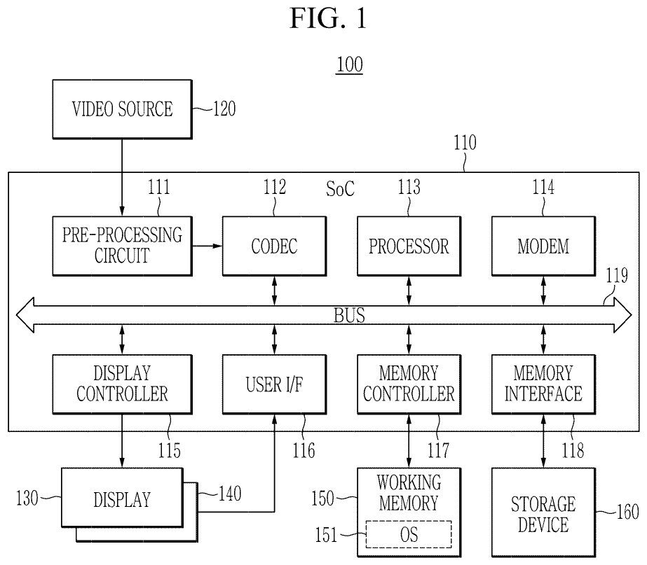

FIG. 1 is a block diagram of a video coding device including a system-on-chip according to some example embodiments.

Referring to FIG. 1, a video coding device 100 may be implemented as a TV, a digital TV (DTV), an Internet protocol TV (IPTV), a set-top box, a personal computer (PC), a laptop computer, a desktop computer, a computer workstation, a smart phone, a tablet PC, a digital camera, a video game platform (or a video game console), a server, or the like. The video coding device 100 may refer to various devices capable of processing two-dimensional (2D) or 3D graphics data and displaying the processed data.

The video coding device 100 may include a system-on-chip (SoC) 110, a video source 120, a display 130, an input device 140, a working memory 150, and a memory interface 118.

The video source 120 may be implemented as a camera equipped with a CCD or CMOS image sensor. The video source 120 may photograph a subject, generate data on the subject, and provide the generated data to the SoC 110.

The SoC 110 may control the overall operation of the video coding device 100. For example, the SoC 110 may include an integrated circuit (IC), a motherboard, an application processor (AP), or a mobile AP. The SoC 110 may process data output from the video source 120, and display the processed data through the display 130, store the processed data in a storage device 160, or transmit the processed data to another data processing system. The data output from the video source 120 may be transmitted to a pre-processing circuit 111 via an interface, for example, a mobile industry processor interface (MIPI) camera serial interface (CSI).

The SoC 110 may include the pre-processing circuit 111, a codec 112, a processor 113, a modem 114, a display controller 115, a user interface 116, a memory controller 117, the memory interface 118, and a bus 119.

The codec 112, the processor 113, the modem 114, the display controller 115, the user interface 116, the memory controller 117, and the memory interface 118 may transmit and receive data to and from one another via the bus 119. For example, the bus 119 may be implemented with at least one selected from peripheral component interconnect bus (PCI bus), a PCI express (PCIe) bus, an advanced microcontroller bus architecture (AMBA), an advanced high performance bus (AHB), an advanced peripheral bus (APB), an advance extensible interface (AXI) bus, and combinations thereof, but is not limited thereto.

The pre-processing circuit 111 may receive data output from the video source 120. The pre-processing circuit 111 may process the received data, and output the processed data to the codec 112. The pre-processing circuit 111 may be implemented, for example, as an image signal processor (ISP). In FIG. 1, it is shown that the pre-processing circuit 111 is implemented inside the SoC 110; however, the pre-processing circuit 111 may be implemented outside the SoC 110.

The codec 112 may perform an encoding (or encryption) operation on data processed by the pre-processing circuit 111. The codec 112 may perform a decoding (or decryption) operation on data provided from the processor 113 or stored in the working memory 150. The encoding and decoding operations may use encoding and decoding technologies such as joint photographic experts group (JPEG), moving picture experts group (MPEG), MPEG-2, MPEG-4, VC-1, VP9, AV1, H.264, H.265, high efficiency video coding, or the like, but are not limited thereto. The codec 112 may be implemented as a hardware codec or a software codec.

In some example embodiments, the codec 112 may read each of the input data for reading data stored in the working memory 150 (for example, an encoded bitstream of video data) and DPB data on a decoded picture buffer (DPB), from the working memory 150. The codec 112 may decode the encoded bitstream and store a decoded picture in a DPB in the working memory 150 indicated by the DPB data. The codec 112 may store the decoded picture in the DPB indicated by the DPB data, by referring to the flag data of the corresponding DPB data. For example, when the flag data of the DPB data is a first value (for example, “0”), the codec 112 may not store the decoded picture in the DPB indicated by the DPB data. The codec 112 may wait until the flag data of the DPB data changes to a second value (for example, “1”) different from the first value. When the flag data of the DPB data is the second value, the codec 112 may store the decoded picture in a first DPB indicated by the DPB data.

The processor 113 may control the operation of the SoC 110. The processor may execute software (application programs, an operating system, and/or device drivers). The processor 113 may execute an operating system (OS) loaded in the working memory 150. The processor 113 may execute various application programs to be run on the operating system (OS). The processor 113 may be provided as a homogeneous multi-core processor or a heterogeneous multi-core processor.

The modem 114 may output data encoded by the codec 112 or the processor 113 to the outside, using a wireless communication technology. The modem 114 may be configured as a unidirectional communication interface or a bidirectional communication interface, and may be configured, for example, to transmit and receive messages for establishing a connection and check and exchange any other information related to data transmission such as transmission of a communication link and/or encoded data.

The display controller 115 may transmit data output from the codec 112 or the processor 113 to the display 130. The display controller 115 may transmit data to the display 130 via a MIPI display serial interface (DSI). The display 130 may be or include an arbitrary type of display configured to show decoded pictures, such as an integrated or external display or monitor. For example, the display may include, a liquid crystal display (LCD), an organic light emitting diode (OLED) display, a plasma display, a projector, a micro LED display, liquid crystal on silicon (LCoS), a digital light processor (DLP), or any other type of display.

The input device 140 may receive a user input, input by a user, and transmit an input signal as a response to a user manipulation to the user interface 116. The input device 140 may be implemented as a touch panel, a touch screen, a voice recognizer, a touch pen, a keyboard, a mouse, a trackpoint, or the like, but is not limited thereto. For example, when the input device 140 is a touch screen, the input device 140 may include a touch panel and a touch panel controller. Also, when the input device 140 is a voice recognizer, the input device 140 may include a voice recognition sensor and a voice recognition controller. The input device 140 may be connected to the display 130, and may also be implemented separately from the display 130.

The user interface 116 may receive an input signal from the input device 140 and transmit data generated by an input manipulation to the processor 113.

The memory controller 117 may read data stored in the working memory 150, under the control of the codec 112 or the processor 113, and transmit the read data to the codec 112 or the processor 113. Further, the memory controller 117 may write data output from the codec 112 or the processor 113 in the working memory 150 under the control of the codec 112 or the processor 113.

The working memory 150 may receive and store data encoded and/or decoded by the codec 112. Further, the working memory 150 may transmit data stored in the working memory 150 to the processor 113 or the modem 114. In some example embodiments, input data and DPB data may be stored in different memory areas in the working memory 150. In other words, in an area in the working memory 150 which includes consecutive addresses, at least one piece of input data may be stored, and another area including consecutive addresses, at least one piece of DPB data may be stored. One area and another area may be discontinuously arranged in the working memory 150.

The working memory 150 may be implemented as a volatile memory. The volatile memory may be implemented as a random access memory (RAM), a static RAM (SRAM), a dynamic RAM (DRAM), a synchronous DRAM (SDRAM), a thyristor RAM (T-RAM), a zero capacitor RAM (Z-RAM), or a twin transistor RAM (TTRAM).

The memory interface 118 accesses the storage device 160 in response to a request of the processor 113. In other words, the memory interface 118 provides an interface between the system-on-chip (SoC) and the storage device 160. For example, data processed by the processor 113 is stored in the storage device 160 via the memory interface 118. As another example, data stored in the storage device 160 may be provided to the processor 113 via the memory interface 118.

The storage device 160 may be provided as a storage medium of the video coding device 100. The storage device 160 may store user data, an OS image, application programs, and the like. The storage device 160 may be implemented as a non-volatile memory.

The non-volatile memory may be implemented as an electrically erasable programmable read-only memory (EEPROM), a flash memory, a magnetic RAM (MRAM), a spin-transfer torque MRAM, a ferroelectric RAM (FeRAM), a phase change RAM (PRAM), or a resistive RAM (RRAM). Alternatively, the non-volatile memory may be implemented as a multimedia card (MMC), an embedded MMC (eMMC), a universal flash storage (UFS), a solid state drive or solid state disk (SSD), a USB flash drive, or a hard disk drive (HDD).

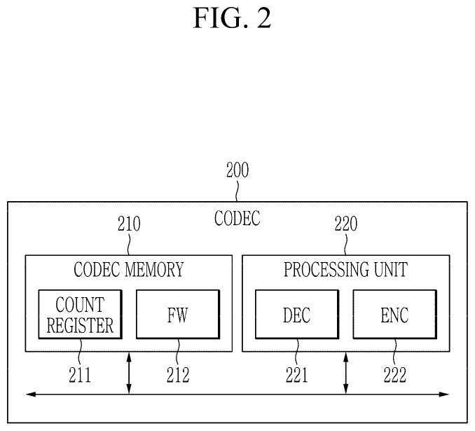

FIG. 2 is a block diagram illustrating a codec according to some example embodiments.

Referring to FIG. 2, a codec 200 may restore an encoded bitstream to a decoded picture by decoding, and encode a picture to generate an encoded bitstream. The codec 200 may include a codec memory 210 and a processing unit 220.

The codec memory 210 may be a write buffer or read buffer connected to temporarily store data input to the codec 200. The codec memory 210 may be configured to store a variety of information required for the codec 200 to operate. For example, the codec memory 210 may store software, firmware, and/or information related to encoding operations and decoding operations. In some example embodiments, the codec memory 210 may be an SRAM; however, the scope of the present inventions are not limited thereto, and the codec memory 210 may be implemented as various types of memory devices such as a DRAM, an MRAM, or a PRAM. In FIG. 2, it is shown for simplicity of the drawing and ease of explanation that the codec memory 210 is included in the codec 200; however, the scope of the present inventions are not limited thereto. The codec memory 210 may be positioned outside the codec 200, and the codec 200 may perform communication with a buffer memory via a separate communication channel or interface.

The codec memory 210 may include a count register 211. The count register 211 may include a first count register that is referred to in order to read input data, a second count register that indicates an index where processing of input data has been completed, and a third count register that is referred to in order to store output data. In some example embodiments, when input data is written in the working memory, the count value of the first count register may be increased. For example, the processor 113 may store the input data in the working memory 150, and change the value of the first count register of the codec 200. The codec 200 may determine an address in the working memory 150 with reference to the count value of the first count register, and read input data stored at the determined address. Further, in some example embodiments, the second count register may count the number of input data that have been decoded. In some example embodiments, the third count register may count the number of times of decoding. When the codec 200 completes decoding of an encoded bitstream, the third count register may increase the number of times of decoding. The codec 200 may determine an address in the working memory 150 with reference to the count value of the third count register, and write output data related to a decoded picture at the determined address.

Firmware 212 may be loaded in the codec memory 210. The firmware 212 may transmit preprocessed picture data and encoded bitstreams to the codec processing unit 220. For example, when the codec 200 receives an interrupt signal from the processor 113, the firmware 212 may read input data stored in the working memory 150 by the processor 113. The firmware 212 may transmit an encoded bitstream read on the basis of the input data, to the codec processing unit 220. In some example embodiments, the firmware 212 may read DPB data, and may or may not use the DPB indicated by the DPB data, with reference to the flag data of the DPB data. The firmware 212 may change the value of the flag data of DPB data indicating a used DPB. For example, when the flag data of DPB data is the second value, the firmware 212 may store a decoded picture in the DPB indicated by the DPB data. If the DPB indicated by the DPB data is used, the firmware 212 may change the flag data of the DPB data from the second value to the first value. When the flag data of the DPB data is the first value, the firmware 212 may not use the DPB indicated by the DPB data. The firmware 212 may use a read pointer to read DPB data. The read pointer may sequentially indicate DPB areas in the working memory 150 containing a plurality of pieces of DPB data. The read pointer may circularly indicate the DPB areas in the working memory 150 containing the plurality of pieces of DPB data.

The codec memory 210 may include a special function register (SFR). The special function register may be used to decode encoded bitstreams in an interlaced scan manner.

The processing unit 220 may include a decoder 221 that decodes an encoded bitstream received from the firmware 212, and an encoder 222 that encodes preprocessed picture data.

The decoder 221 may receive an encoded bitstream and provide a decoded picture. The encoder 222 (also referred to as the video encoder) may receive a preprocessed picture data, process the preprocessed picture data, and provide an encoded bitstream.

Each of the decoder 221 and the encoder 222 may be implemented with various appropriate circuits, for example, one or more microprocessors, digital signal processors (DSPs), application-specific integrated circuits (ASICs), field programmable gate arrays (FPGAs), discrete logics, hardware, or any combination thereof. If this technique is partially implemented using software, the device may store software instructions in an appropriate non-transitory computer-readable storage medium, and execute the instructions using hardware such as one or more processors to perform the technique of the present disclosure. Any of the above (including hardware, software, a combination of hardware and software, and the like) may be considered as one or more processors.

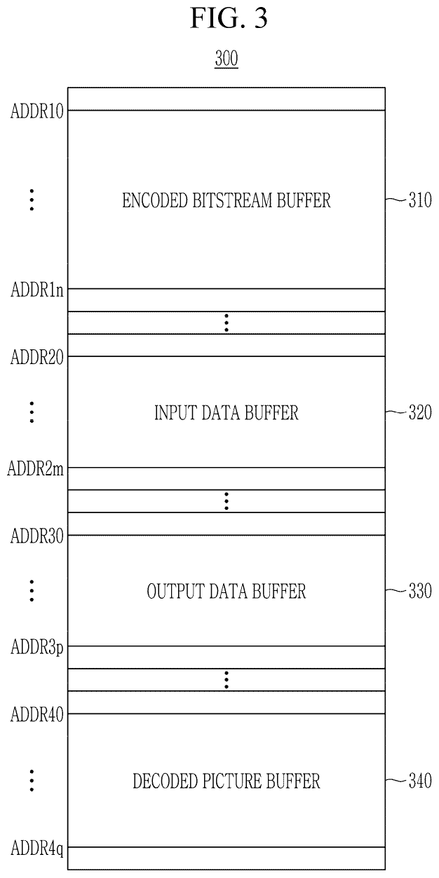

FIG. 3 is a diagram illustrating a working memory according to a comparative example.

Referring to FIG. 3, a working memory 300 may include a plurality of buffer areas 310, 320, 330, and 340. In the first area 310, encoded bitstreams may be stored. In the second area 320, input data may be stored. In the third area 330, output data may be stored. In the fourth area 340, decoded pictures may be stored. The first to fourth areas 310, 320, 330, and 340 may be arranged discontinuously in the working memory 300, and the sizes of the individual areas may be variously set. Hereinafter, the first to fourth areas 310, 320, 330, and 340 will be referred to as an encoded bitstream buffer, an input data buffer, an output data buffer, and a decoded picture buffer, respectively.

In some example embodiments, an operating system 151 may allocate an address range from ADDR10 to ADDR1n in the working memory 300 as the first area 310, allocate an address range from ADDR20 to ADDR2m as the second area 320, allocate an address range from ADDR30 to ADDR3p as the third area 330, and allocate an address range from ADDR40 to ADDR4q as the fourth area 340. The first area 310 may include a plurality of encoded bitstream buffer areas in the address range from ADDR10 to ADDR1n. The second area 320 may include a plurality of input data buffer areas in the address range from ADDR20 to ADDR2m. The third area 330 may include a plurality of output data buffer areas in the address range from ADDR30 to ADDR3p. The fourth area 340 may include a plurality of DPB areas in the address range from ADDR40 to ADDR4q. Here, n, m, p, and q may be any natural number greater than 0 (for example, together or independently, 5, 10, 15, etc.).

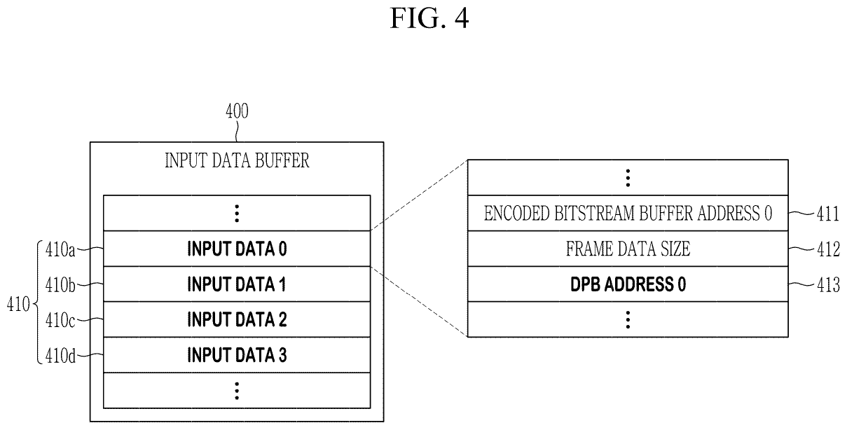

FIG. 4 is a diagram illustrating an input data buffer of the working memory according to the comparative example.

Referring to FIG. 4, an input data buffer 400 may include a plurality of pieces of input data 410. One piece of input data 410a may contain information on an encoded bitstream buffer address 411, a flag data size 412, and a DPB address 413. The input data 410 may be generated by the processor 113. When the operating system 151 allocates a DPB for storing encoded bitstream data to the processor 113, the processor may generate input data 410 including information on the DPB address 413 indicating the allocated DPB.

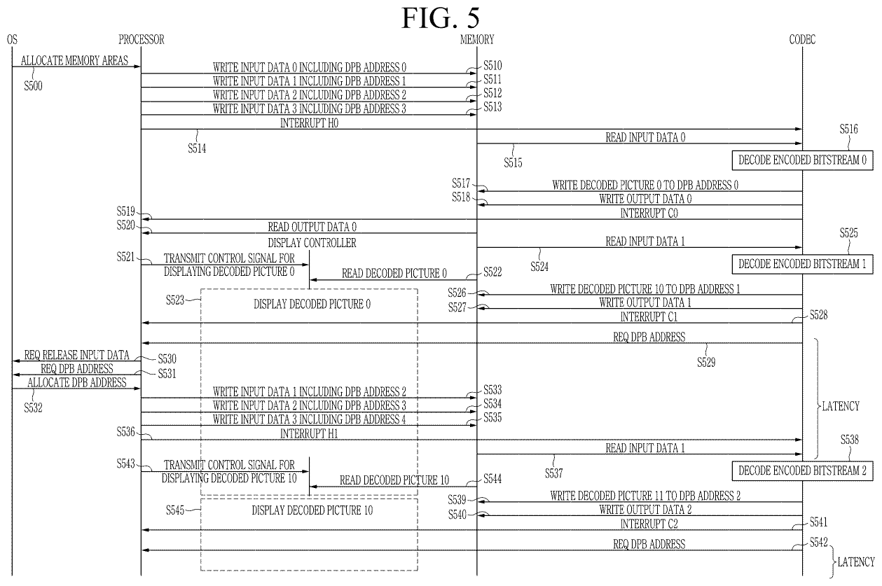

FIG. 5 is a flow chart illustrating a decoding method of the comparative example.

Referring to FIGS. 1 to 5, the operating system 151 allocates the plurality of buffer areas 310, 320, 330, and 340 in the working memory 300, and notifies the processor 113 of the information on the plurality of buffer areas 310, 320, 330, and 340 (S500). For example, the operating system 151 may notify the processor 113 of the information on the addresses of the plurality of buffer areas and the sizes of the individual areas. The processor 113 may transmit the information on the plurality of buffer areas 310, 320, 330, and 340 to the codec 112.

The processor 113 stores input data including the DPB addresses in the working memory 150 (S510 to S513). The processor 113 may generate input data including the addresses in the encoded bitstream buffer where the encoded bitstreams have been stored, the sizes of the encoded bitstreams, and the DPB addresses. For example, in response to a plurality of encoded bitstreams, the processor 113 may generate input data including DPB addresses 0, 1, 2, and 3, respectively. The processor 113 may store the input data generated in response to the plurality of encoded bitstreams, in the input data buffer in the working memory 150.

If storing the input data items, the processor 113 transmits an interrupt signal INTERRUPT H0 to the codec 112 (S514). The processor 113 may transmit the interrupt signal INTERRUPT H0 whenever storing of an input data is completed or when storing of a predetermined (or, alternatively, desired or selected) number of input data is completed. The interrupt signal INTERRUPT H0 that is transmitted as storing a predetermined (or, alternatively, desired or selected) number of input data is completed may include the number of stored input data items.

The codec 112 reads an input data INPUT DATA 0 from the input data buffer of the working memory 150 on the basis of the interrupt signal INTERRUPT H0 (S515). The codec 112 may receive an address range of the input data buffer from the processor 113 before OPERATION S515. When receiving the interrupt signal INTERRUPT H0 for the first time, the codec 112 may read the input data INPUT DATA 0 from a base address of the input data buffer.

The codec 112 decodes an encoded bitstream ENCODED BITSTREAM 0 stored in the encoded bitstream buffer address with reference to the input data INPUT DATA 0 (S516). The codec 112 may read the encoded bitstream ENCODED BITSTREAM 0 from the working memory 150 on the basis of the encoded bitstream buffer address included in the input data INPUT DATA 0, and decodes the encoded bitstream ENCODED BITSTREAM 0 to generate a decoded picture DECODED PICTURE 0.

The codec 112 writes the decoded picture DECODED PICTURE 0 in a DPB with reference to the input data INPUT DATA 0 (S517). The codec 112 may write the decoded picture DECODED PICTURE 0 in the working memory 150 on the basis of a DPB address DPB ADDRESS 0 included in the input data INPUT DATA 0.

The codec 112 writes an output data OUTPUT DATA 0 related to the decoded picture DECODED PICTURE 0 in the output data buffer (S518). When completing decoding for the first time, the codec 112 may write the output data in a base address of the output data buffer.

When the writing of the output data is completed, the codec 112 transmits an interrupt signal INTERRUPT C0 to the processor 113 (S519).

The processor 113 receives the interrupt signal INTERRUPT C0, and reads the output data OUTPUT DATA 0 from the output data buffer (S520). The processor 113 may determine the address in the output data buffer where the output data OUTPUT DATA 0 has been stored, on the basis of the number of times the interrupt signal INTERRUPT C0 has been received. The processor 113 may read the output data OUTPUT DATA 0 from the determined address.

The processor 113 transmits a control signal for displaying the decoded picture DECODED PICTURE 0 to the display controller 115 (S521). The control signal may include the DPB address DPB ADDRESS 0 determined on the basis of the output data OUTPUT DATA 0.

The display controller 115 reads the decoded picture DECODED PICTURE 0 stored at the DPB address DPB ADDRESS 0 of the DPB (S522).

The display controller 115 may display the decoded picture DECODED PICTURE 0 on the display 130 (S523).

After transmitting the interrupt signal INTERRUPT C0, the codec 112 reads an input data INPUT DATA 1 from the input data buffer (S524). When decoding is completed, the codec 112 may read the input data INPUT DATA 1 from the next address of the base address of the input data buffer (for example, an address obtained by adding the product of the index of input data for which decoding has been completed (such as the count value of the second count register) and an offset address size to the base address).

The codec 112 decodes an encoded bitstream ENCODED BITSTREAM 1 stored at an encoded bitstream buffer address with respect to the input data INPUT DATA 1 (S525). The codec 112 may read the encoded bitstream ENCODED BITSTREAM 1 from the working memory 150 on the basis of the encoded bitstream buffer address included in the input data INPUT DATA 1, and decodes the encoded bitstream ENCODED BITSTREAM 1 to generate a decoded picture DECODED PICTURE 1.

The encoded bitstream ENCODED BITSTREAM 1 may be multi-frame data. In other words, the encoded bitstream ENCODED BITSTREAM 1 may be one bitstream into which pictures of several frames have been encoded. The encoded bitstream ENCODED BITSTREAM 1 may be encoded by an encoding technology such as VP9, AV1, or the like.

The codec 112 writes the decoded picture DECODED PICTURE 1 in a DPB with reference to the input data INPUT DATA 1 (S526). When the encoded bitstream ENCODED BITSTREAM 1 includes pictures of three frames, the codec 112 may complete decoding of the picture of one frame and write the picture of one frame on which decoding has been completed, in the DPB. The codec 112 may write the decoded picture DECODED PICTURE 1 in the working memory 150 on the basis of a DPB address DPB ADDRESS 1 included in the input data INPUT DATA 1.

The codec 112 writes an output data OUTPUT DATA 1 related to the decoded picture DECODED PICTURE 1 in the output data buffer (S527). The codec 112 may write the output data OUTPUT DATA 1 at the next address of the base address of the output data buffer.

When writing the output data OUTPUT DATA 1 is completed, the codec 112 transmits an interrupt signal INTERRUPT C1 to the processor 113 (S528).

When the encoded bitstream ENCODED BITSTREAM 1 includes undecoded data, the codec 112 requests a DPB address from the processor 113 (S529).

The encoded bitstream ENCODED BITSTREAM 1 may include information on the number of encoded pictures. The codec 112 may decode the encoded bitstream ENCODED BITSTREAM 1, and determine whether decoding the encoded pictures of the encoded bitstream ENCODED BITSTREAM 1 has been completed, on the basis of the information on the number of encoded pictures.

When completing decoding of the picture of one frame from the encoded bitstream ENCODED BITSTREAM 1, the codec 112 may determine whether decoding of the encoded pictures in the encoded bitstream ENCODED BITSTREAM 1 has been completed, on the basis of whether the encoded bitstream ENCODED BITSTREAM 1 includes undecoded data. The encoded bitstream ENCODED BITSTREAM 1 may include information on the size of the encoded bitstream ENCODED BITSTREAM 1. The codec 112 may determine whether the encoded bitstream ENCODED BITSTREAM 1 includes undecoded data, by comparing the size of the encoded bitstream ENCODED BITSTREAM 1 and the size of decoded data of the encoded bitstream ENCODED BITSTREAM 1.

Since the encoded bitstream ENCODED BITSTREAM 1 is multi-frame data, even after operation S525 is performed, the encoded bitstream ENCODED BITSTREAM 1 may include undecoded data. The codec 112 may decode the undecoded data included in the encoded bitstream ENCODED BITSTREAM 1, for example, the remaining data. However, since each input data includes one DPB address, the input data INPUT DATA 1 of the encoded bitstream ENCODED BITSTREAM 1 may also include only one DPB address DPB ADDRESS 1. Accordingly, if the decoded picture DECODED PICTURE 1 is stored at the DPB address DPB ADDRESS 1, the codec 112 requires an additional DPB address for storing a picture to be obtained by decoding the data required to be decoded (for example, the remaining data).

The processor 113 requests the operating system 151 to release the memory allocated to the input data (S530). The operating system 151 may release the input data stored in the working memory 300. Each input data may include one DPB address, and the codec 112 may read the input data sequentially from the base address of the input data buffer in which the input data have been stored. Accordingly, when an input data INPUT DATA 1 including a new DPB address (for example, a DPB address DPB ADDRESS 2) is additionally stored in the input data buffer, decoding of an encoded bitstream indicated by the input data INPUT DATA 1 is required to be performed after decoding of the encoded bitstreams indicated by the other input data INPUT DATA 2, INPUT DATA 3 stored in the input data buffer is completed, and thus the throughput of the codec memory 210 may decrease. Further, when the display order of the decoded pictures is the order of the input data INPUT DATA 1, the input data INPUT DATA 2, and the input data INPUT DATA 3, decoding of the encoded bitstream indicated by the input data INPUT DATA 1 is performed after decoding of the encoded bitstream indicated by the input data INPUT DATA 3 is completed, and thus display of the input data INPUT DATA 1 may not be normally performed. For this reason, the processor 113 may request the operating system 151 to release the input data from the working memory, and store the input data sequentially from the base address of the input data buffer. Further, the count register 211 that is used to read input data of the codec 200 may be reset.

The processor 113 may request the operating system 151 to allocate a DPB address (S531).

The operating system 151 allocates a used DPB address to the processor 113 (S532). For example, the operating system 151 may allocate a DPB address already read (for example used) by the display controller 115 as a new DPB address to the processor 113.

The processor 113 stores the input data including the new DPB address in the working memory 150 (S533 to S535). The processor 113 may generate input data including DPB addresses 2, 3, and 4 in response to a plurality of encoded bitstreams, respectively. The processor 113 may store the input data generated in response to the plurality of encoded bitstreams, in the input data buffer in the working memory 150.

storing the input data items, the processor 113 transmits an interrupt signal INTERRUPT H1 to the codec 112 (S536).

The codec 112 reads the input data INPUT DATA 1 from the input data buffer of the working memory 150 on the basis of the interrupt signal INTERRUPT H1 (S537). Since the count register 211 of the codec 112 has been reset, when the codec 112 receives the interrupt signal INTERRUPT H1, it may read the input data INPUT DATA 1 from the base address of the input data buffer.

The codec 112 decodes the encoded bitstream ENCODED BITSTREAM 1 with reference to the input data INPUT DATA 1 (S538). When the encoded bitstream buffer address included in the input data INPUT DATA 1 is the same as the encoded bitstream buffer address included in the input data INPUT DATA 1 read in operation S524, the codec 112 may decode the undecoded remaining data in operation S525. The codec 112 may decode the remaining data of the encoded bitstream ENCODED BITSTREAM 1 to generate a decoded picture DECODED PICTURE 11.

The codec 112 writes the decoded picture DECODED PICTURE 11 in a DPB with reference to the input data INPUT DATA 1 (S539). The codec 112 may write the decoded picture DECODED PICTURE 11 in the working memory 150 on the basis of the DPB address DPB ADDRESS 2 included in the input data INPUT DATA 1.

The codec 112 writes an output data OUTPUT DATA 2 related to the decoded picture DECODED PICTURE 11 in the output data buffer (S540). The codec 112 may write the output data OUTPUT DATA 2 at the next address of the address of the output data buffer where the output data OUTPUT DATA 1 has been stored.

When the writing of the output data OUTPUT DATA 2 is completed, the codec 112 transmits an interrupt signal INTERRUPT C2 to the processor 113 (S541).

When the encoded bitstream ENCODED BITSTREAM 1 includes undecoded data, the codec 112 requests a DPB address from the processor 113 again (S542).

The processor 113 transmits a control signal for displaying the decoded picture DECODED PICTURE 10 to the display controller 115 (S543). The control signal may include the DPB address DPB ADDRESS 1 determined on the basis of the output data OUTPUT DATA 1.

The display controller 115 reads the decoded picture DECODED PICTURE 10 stored at the DPB address DPB ADDRESS 1 of the DPB (S544).

The display controller 115 may display the decoded picture DECODED PICTURE 10 on the display 130 (S545).

Latency may be caused by operations S529 to S537 and/or operation S542 of decoding the encoded bitstream ENCODED BITSTREAM 1 which is multi-frame data and requesting a DPB address from the processor 113 and the operating system 151 to store the decoded pictures. This latency is greater than the time it takes for the codec 112 to decode a picture of one frame.

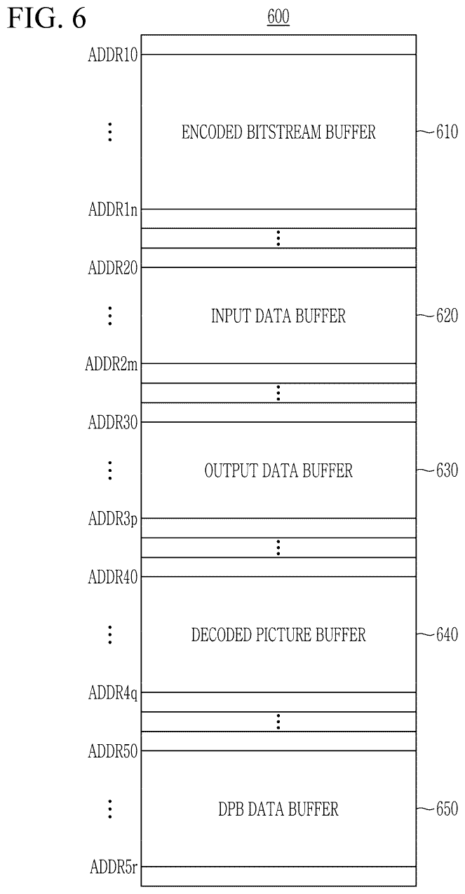

FIG. 6 is a diagram illustrating a working memory according to some example embodiments.

Referring to FIG. 6, a working memory 600 may include a plurality of buffer areas 610, 620, 630, 640, and 650. In the first area 610, encoded bitstreams may be stored. In the second area 620, input data may be stored. In the third area 630, output data may be stored. In the fourth area 640, decoded pictures may be stored. In the fifth area 650, DPB data may be stored. In some example embodiments, input data may not include information on DPB addresses, and DPB data may include information on DPB addresses. The first to fifth areas 610, 620, 630, 640, and 650 may be arranged discontinuously in the working memory 600, and the sizes of the individual areas may be variously set. Hereinafter, the fifth region 650 will be referred to as the DPB data buffer.

In some example embodiments, an operating system 151 may allocate an address range from ADDR10 to ADDR1n in the working memory 600 as the first area 610, allocate an address range from ADDR20 to ADDR2m as the second area 620, allocate an address range from ADDR30 to ADDR3p as the third area 630, allocate an address range from ADDR40 to ADDR4q as the fourth area 640, and allocate an address range from ADDR50 to ADDR5r as the fifth area 650. Here, n, m, p, q, and r may be any natural number greater than 0 (for example, together or independently, 2, 5, 15, etc.).

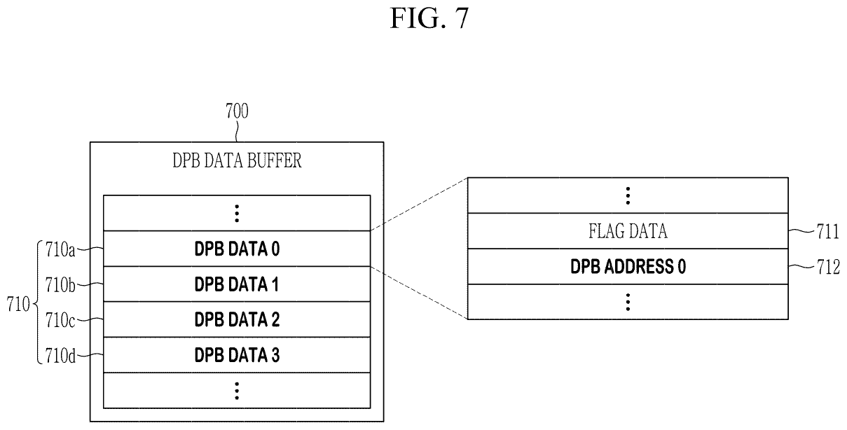

FIG. 7 is a diagram illustrating a DPB data buffer of a working memory accuracy according to some example embodiments.

Referring to FIG. 7, a DPB data buffer 700 may include a plurality of DPB data 710. One DPB data 710a may include flag data 711 and information on a DPB address 712. The flag data 711 may indicate whether the DPB data 710a is available. When the operating system 151 allocates a DPB for storing encoded bitstream data to the processor 113, the processor may generate a DPB data 710 including information on the DPB address 712 indicating the allocated DPB.

In some example embodiments, the processor 113 may update the DPB data 710a on the basis of the flag data 711 of the DPB data 710a. For example, when the flag data 711 of the DPB data 710a is a first value, the processor 113 may change the flag data 711 of the DPB data 710a to a second value, and store the information on the allocated DPB address in the DPB data 710a. In other words, the processor may write a DPB data 710a including the flag data 711 having the second value and the information on the allocated DPB address, at the address where the DPB data 710a has been stored. After storing the new DPB data 710a, the processor 113 may read the next DPB data 710b of the DPB data 710a. When the flag data 711 of the DPB data 710a is the second value, the processor 113 may wait until the flag data 711 of the DPB data 710a is changed to the first value.

When the flag data 711 of the DPB data 710a is the second value, the codec 112 may store a decoded picture at the DPB address 712 of the DPB data 710a. The codec 112 may store the decoded picture at the DPB address 712 and change the flag data 711 of the DPB data 710a to the first value. After using the DPB data 710a, the codec 112 may read the next DPB data 710b of the DPB data 710a. When the flag data 711 of the DPB data 710a is the first value, the codec 112 may wait until the flag data 711 of the DPB data 710a is changed to the second value.

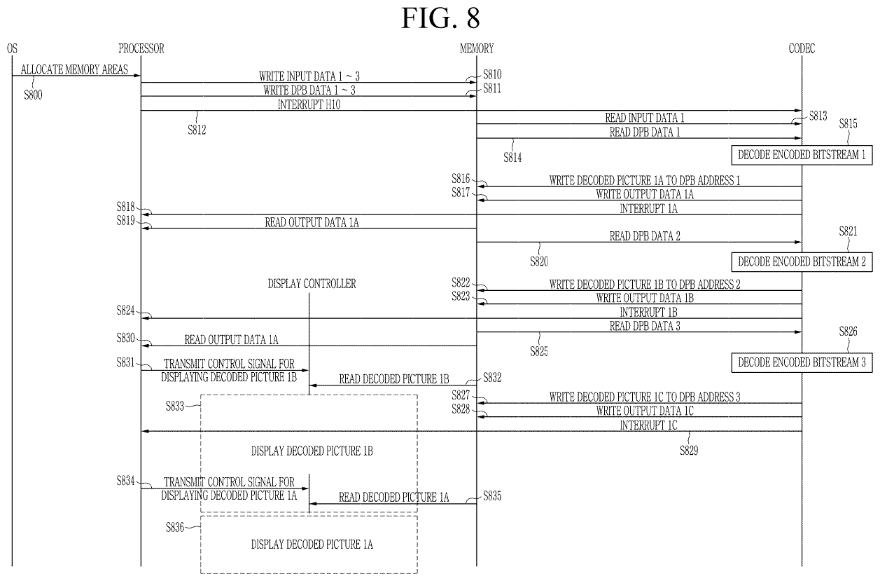

FIG. 8 is a flow chart illustrating a decoding method according to some example embodiments.

Referring to FIG. 1, FIG. 2, and FIGS. 6 to 8, the operating system 151 allocates the plurality of buffer areas 610, 620, 630, 640, and 650 in the working memory 600, and notifies the processor 113 of the information on the plurality of buffer areas 610, 620, 630, 640, and 650 (S800). For example, the operating system 151 may notify the processor 113 of the information on the addresses of the plurality of buffer areas and the sizes of the individual areas. The processor 113 may transmit the information on the plurality of buffer areas 610, 620, 630, 640, and 650 to the codec 112.

The processor 113 stores input data in the working memory 150 (S810). The processor 113 may generate input data including the addresses of the encoded bitstream buffer where encoded bitstreams have been stored and the sizes of the encoded bitstreams. For example, the processor 113 may store a plurality of input data INPUT DATA 1 to INPUT DATA 3 generated in response to a plurality of encoded bitstreams, in the input data buffer in the working memory 600.

The processor 113 stores DPB data in the working memory 150 (S811). For example, the processor 113 may generate a plurality of DPB data DPB DATA 1 to DPB DATA 3 corresponding to the plurality of encoded bitstreams. The plurality of DPB data DPB DATA 1 to DPB DATA 3 may include DPB addresses, respectively. The processor 113 may store the plurality of DPB data sequentially from the base address of the DPB data buffer.

If storing the input data and the DPB data items, the processor 113 transmits an interrupt signal INTERRUPT H10 to the codec 112 (S812). The processor 113 may transmit the interrupt signal INTERRUPT H10 whenever storing of an input data and a DPB data is completed or when storing of predetermined (or, alternatively, desired or selected) numbers of input data and DPB data is completed. The interrupt signal INTERRUPT H10 that is transmitted as storing of the predetermined (or, alternatively, desired or selected) numbers of input data and DPB data is completed may include the numbers of stored input data and stored DPB data items.

The codec 112 reads an input data INPUT DATA 1 from the input data buffer of the working memory 150 on the basis of the interrupt signal INTERRUPT H10 (S813). The codec 112 may receive an address range of the input data buffer from the processor 113 before operation S813. When receiving the interrupt signal INTERRUPT H10 for the first time, the codec 112 may read the input data INPUT DATA 1 from the base address of the input data buffer.

The codec 112 reads the DPB data DPB DATA 1 from the DPB data buffer of the working memory 150 on the basis of the interrupt signal INTERRUPT H10 (S814). The codec 112 may receive an address range of the DPB data buffer from the processor 113 before operation S813. When receiving the interrupt signal INTERRUPT H10 for the first time, the codec 112 may read the DPB data DPB DATA 1 from the base address of the DPB data buffer.

The codec 112 decodes an encoded bitstream ENCODED BITSTREAM 1 stored at an encoded bitstream buffer address with respect to the input data INPUT DATA 1 (S815). Here, the encoded bitstream ENCODED BITSTREAM 1 may be multi-frame data. The codec 112 may read the encoded bitstream ENCODED BITSTREAM 1 from the working memory 150 on the basis of the encoded bitstream buffer address included in the input data INPUT DATA 1, and decodes the encoded bitstream ENCODED BITSTREAM 1 to generate a decoded picture DECODED PICTURE 1A.

The codec 112 writes the decoded picture DECODED PICTURE 1A in a DPB with reference to the DPB data DPB DATA 1 (S816). The codec 112 may write the decoded picture DECODED PICTURE 1A in the working memory 150 on the basis of the DPB address DPB ADDRESS 1 included in the DPB data DPB DATA 1.

The codec 112 writes an output data OUTPUT DATA 1A related to the decoded picture DECODED PICTURE 1A in the output data buffer (S817). When completing decoding for the first time, the codec 112 may write the output data in a base address of the output data buffer.

When the writing of the output data is completed, the codec 112 transmits an interrupt signal INTERRUPT 1A to the processor 113 (S818).

The processor 113 receives the interrupt signal INTERRUPT 1A, and reads the output data OUTPUT DATA 1A from the output data buffer (S819). The processor 113 may determine the address in the output data buffer where the output data OUTPUT DATA 1A has been stored, on the basis of the number of times the interrupt signal INTERRUPT 1A has been received. The processor 113 may read the output data OUTPUT DATA 1A from the determined address. The processor 113 may determine the display order of the decoded picture DECODED PICTURE 1A from the output data OUTPUT DATA 1A. Hereinafter, it is assumed that the decoded picture DECODED PICTURE 1A is displayed after a decoded picture DECODED PICTURE 1B is displayed. Accordingly, the processor 113 may not transmit a control signal to the display controller 115 after the output data OUTPUT DATA 1A is read until an output data OUTPUT DATA 1B related to the decoded picture DECODED PICTURE 1B is read.

When the encoded bitstream ENCODED BITSTREAM 1 includes undecoded data, the codec 112 reads a DPB data DPB DATA 2 from the DPB data buffer of the working memory 150 (S820). How the codec 112 determines whether the encoded bitstream ENCODED BITSTREAM 1 includes undecoded data is identical or similar to that in the description of FIG. 5, and thus a description thereof will not be made. When decoding is completed, the codec 112 may read the DPB data DPB DATA 2 from the next address of the base address of the DPB data buffer (for example, an address obtained by adding the product of the number of times decoding has been completed and the offset address size to the base address).

The codec 112 decodes the remaining data of the encoded bitstream ENCODED BITSTREAM 1 (S821). The codec 112 may decode the undecoded data in the encoded bitstream ENCODED BITSTREAM 1 to generate the decoded picture DECODED PICTURE 1B.

The codec 112 writes the decoded picture DECODED PICTURE 1B in a DPB with reference to the DPB data DPB DATA 2 (S822). The codec 112 may write the decoded picture DECODED PICTURE 1B in the working memory 150 on the basis of the DPB address DPB ADDRESS 2 included in the DPB data DPB DATA 2.

The codec 112 writes the output data OUTPUT DATA 1B related to the decoded picture DECODED PICTURE 1B in the output data buffer (S823). The codec 112 may write the output data at the next address of the address of the output data buffer where the output data OUTPUT DATA 1A has been stored.

When the writing of the output data OUTPUT DATA 1B is completed, the codec 112 transmits an interrupt signal INTERRUPT 1B to the processor 113 (S824).

When the encoded bitstream ENCODED BITSTREAM 1 includes undecoded data, the codec 112 reads a DPB data DPB DATA 3 from the DPB data buffer of the working memory 150 (S825).

The codec 112 decodes the remaining data of the encoded bitstream ENCODED BITSTREAM 1 (S826). The codec 112 may decode the undecoded data of the encoded bitstream ENCODED BITSTREAM 1 to generate a decoded picture DECODED PICTURE 1C.

The codec 112 writes the decoded picture DECODED PICTURE 1C in a DPB with reference to the DPB data DPB DATA 3 (S827). The codec 112 may write the decoded picture DECODED PICTURE 1C in the working memory 150 on the basis of a DPB address DPB ADDRESS 3 included in the DPB data DPB DATA 3.

The codec 112 writes an output data OUTPUT DATA 1C related to the decoded picture DECODED PICTURE 1C in the output data buffer (S828). The codec 112 may write the output data at the next address of the address of the output data buffer where the output data OUTPUT DATA 1C has been stored.

When the writing of the output data is completed, the codec 112 transmits an interrupt signal INTERRUPT 1C to the processor 113 (S829).

The processor 113 receives the interrupt signal INTERRUPT 1B, and reads the output data OUTPUT DATA 1B from the output data buffer (S830). The processor 113 may determine the address in the output data buffer where the output data OUTPUT DATA 1B has been stored, on the basis of the number of times the interrupt signal INTERRUPT 1B has been received. The processor 113 may read the output data OUTPUT DATA 1B from the determined address.

The processor 113 transmits a control signal for displaying the decoded picture DECODED PICTURE 1B to the display controller 115 (S831). The control signal may include the DPB address DPB ADDRESS 2 determined on the basis of the output data OUTPUT DATA 1B.

The display controller 115 reads the decoded picture DECODED PICTURE 1B stored at the DPB address DPB ADDRESS 2 of the DPB (S832).

The display controller 115 may display the decoded picture DECODED PICTURE 1B on the display 130 (S833).

The processor 113 transmits a control signal for displaying the decoded picture DECODED PICTURE 1A to the display controller 115 (S834). The control signal may include the DPB address DPB ADDRESS 1 determined on the basis of the output data OUTPUT DATA 1A.

The display controller 115 reads the decoded picture DECODED PICTURE 1A stored at the DPB address DPB ADDRESS 1 of the DPB (S835).

The display controller 115 may display the decoded picture DECODED PICTURE 1A on the display 130 (S836).

According to some example embodiments, when the codec 112 requires a DPB address, it reads a DPB address from the DPB data buffer without requiring an additional DPB address, and thus the latency according to DPB address allocation (see “LATENCY” in FIG. 5) may be reduced.

For example, according to some example embodiments, there may be an increase in speed, accuracy, and/or power efficiency of the memory device based on the above decoding methods. Therefore, the improved devices and methods overcome the deficiencies of the conventional devices and methods of decoding data related to decoding/encoding image data while reducing resource consumption, data accuracy, and resource allocation (e.g., latency). Further, there is an improvement in communication and reliability in the device by providing the abilities disclosed herein, for example, related to DPB addresses and memory storage architecture.

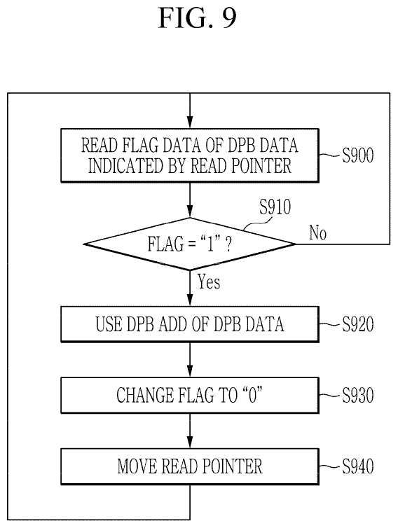

Hereinafter, how the codec 112 and the processor 113 use the DPB data buffer will be described with reference to FIGS. 9 to 12.

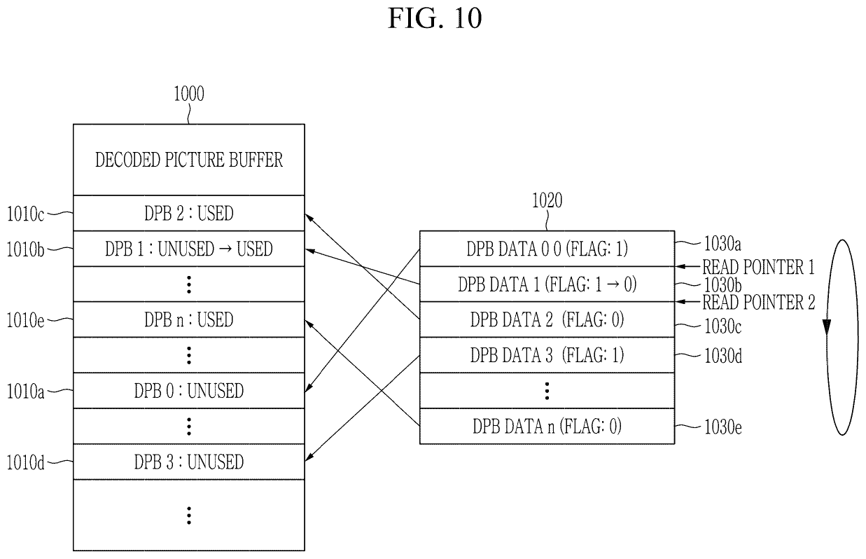

FIG. 9 is a flow chart illustrating a method of using DPB data in the DPB data buffer according to some example embodiments, and FIG. 10 is a diagram illustrating a DPB and a DPB data buffer according to some example embodiments.

Referring to FIGS. 9 and 10, the codec 112 reads the flag data of a DPB data 1030b indicated by a read pointer READ POINTER 1 from a DPB data buffer 1020 (S900). The DPB data buffer 1020 may contain a plurality of DPB data 1030a to 1030e. A DPB 1000 may include a plurality of DPB areas 1010a to 1010e. Each of the plurality of DPB areas 1010a to 1010e may store decoded pictures. The DPB areas 1010c and 1010e containing decoded pictures may be in a “USED” state and the DPB areas 1010a, 1010b, and 1010d containing no decoded pictures may be in an “UNUSED” state. The plurality of DPB data 1030a to 1030e may indicate the plurality of DPB areas 1010a to 1010e. The flag data of the plurality of DPB data 1030a to 1030e may have a first value (“0”) when the DPB areas 1010a to 1010e indicated by the plurality of DPB data 1030a to 1030e are in the “USED” state, and may have a second value (“1”) when the DPB areas 1010a to 1010e indicated by the plurality of DPB data 1030a to 1030e are in the “UNUSED” state.

The codec 112 determines whether the value of the flag data is the second value (“1”) (S910). The codec 112 may determine whether the DPB area 1010b indicated by the DPB data 1030b is in the “USED” state or in the “UNUSED” state, on the basis of the value of the flag data of the DPB data 1030b.

When the flag data of the DPB data 1030b is the second value (“1”), the codec 112 uses the DPB address 1010b of the DPB data 1030b (S920). For example, when the DPB area 1010b indicated by the DPB data 1030b is in the “UNUSED” state, the codec 112 may store a decoded picture at the DPB address 1010b.

The codec 112 changes the flag data of the DPB data 1030b to the first value (“0”) (S930). The codec 112 may change the flag data of the DPB data 1030b to the first value (“0”) to indicate that the DPB area 1010b indicated by the DPB data 1030b is in the “USED” state.

When the flag data of the DPB data 1030b is the first value (“0”), the codec 112 may read the flag data of the DPB data 1030b indicated by the read pointer READ POINTER 1 from the DPB data buffer 1020 again. The codec 112 may re-read the flag data of the DPB data 1030b at a predetermined (or, alternatively, desired or selected) interval. Thus, the codec 112 may wait until the flag data of the DPB data 1030b is changed to the second value (“1”).

After the DPB data 1030b is used, the read pointer is increased/moved (S940). Then, the codec 112 may read the DPB data 1030c indicated by a read pointer READ POINTER 2. The read pointer may indicate a DPB data to be read while circulating through the DPB data buffer 1020. For example, the read pointer may indicate an address of the DPB data buffer 1020 where the last DPB data 1030e has been stored, in OPERATION S900, and be increased in OPERATION S940 to indicate the base address.

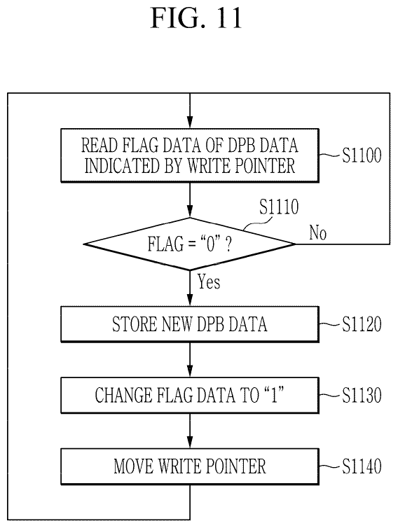

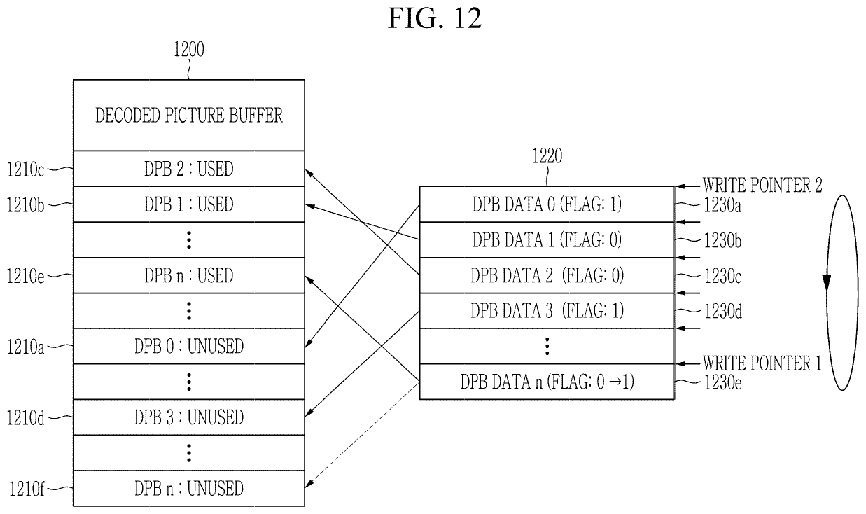

FIG. 11 is a flow chart illustrating a method of updating DPB data in the DPB data buffer according to some example embodiments, and FIG. 12 is a diagram illustrating a DPB and a DPB data buffer according to some example embodiments.

Referring to FIGS. 11 and 12, the processor 113 reads the flag data of a DPB data 1230e indicated by a write pointer WRITE POINTER 1 from the DPB data buffer 1020 (S1100).

The processor 113 determines whether the value of the flag data is the first value (“0”) (S1110). The processor 113 may determine whether a DPB area 1210b indicated by the DPB data 1230e is in the “USED” state or in the “UNUSED” state, on the basis of the value of the flag data of the DPB data 1230e.

When the flag data of the DPB data 1230e is the first value (“0”), the processor 113 stores a DPB data 1230e indicating a new DPB address 1210f (S1120). For example, when the DPB area 1210e indicated by the DPB data 1230e is in the “USED” state, the processor 113 may store the DPB data 1230e indicating the DPB address 1210f having the “UNUSED” state, at the area indicated by the write pointer WRITE POINTER 1.

The processor 113 changes the flag data of the DPB data 1230e to the second value (“1”) (S1130). The processor 113 may change the flag data of the DPB data 1230e to the second value (“1”) to indicate that the DPB area 1210e indicated by the DPB data 1230e is in the “UNUSED” state.

When the flag data of the DPB data 1230e is the second value (“1”), the processor 113 may read the flag data of the DPB data 1230e indicated by the write pointer WRITE POINTER 1 from a DPB data buffer 1220 again. The processor 113 may re-read the flag data of the DPB data 1230e at a predetermined (or, alternatively, desired or selected) interval. Thus, the processor 113 may wait until the flag data of the DPB data 1230e is changed to the first value (“0”).

After the new DPB data 1230e is stored, the write pointer is increased (S1140). Then, the processor 113 may read the next DPB data 1230a of the DPB data 1230e. The write pointer may indicate a DPB data to be read while circulating through the DPB data buffer 1220.

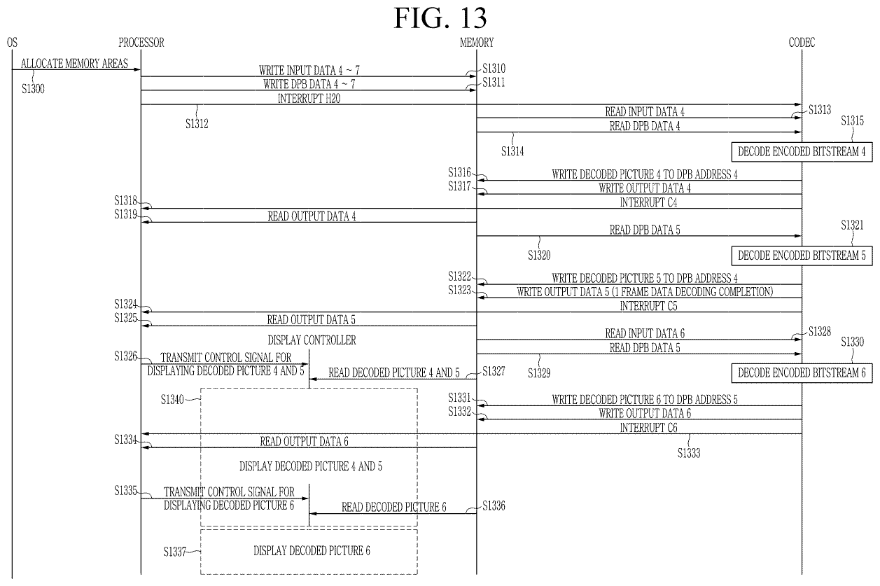

FIG. 13 is a flow chart illustrating a decoding method according to some example embodiments.

Referring to FIG. 1, FIG. 2, FIG. 6, FIG. 7, and FIG. 13, the operating system 151 allocates the plurality of buffer areas 610, 620, 630, 640, and 650 in the working memory 600, and notifies the processor 113 of the information on the plurality of buffer areas 610, 620, 630, 640, and 650 (S1300). For example, the operating system 151 may notify the processor 113 of the information on the addresses of the plurality of buffer areas and the sizes of the individual areas. The processor 113 may transmit the information on the plurality of buffer areas 610, 620, 630, 640, and 650 to the codec 112.

The processor 113 stores input data in the working memory 150 (S1310). The processor 113 may generate input data including the addresses of the encoded bitstream buffer where encoded bitstreams have been stored and the sizes of the encoded bitstreams. For example, the processor 113 may store a plurality of input data INPUT DATA 4 to INPUT DATA 7 generated in response to a plurality of encoded bitstreams, in the input data buffer in the working memory 600.

The processor 113 stores DPB data in the working memory 150 (S1311). For example, the processor 113 may generate a plurality of DPB data DPB DATA 4 to DPB DATA 7 corresponding to the plurality of encoded bitstreams. The plurality of DPB data DPB DATA 4 to DPB DATA 7 may include DPB addresses, respectively. The processor 113 may store the plurality of DPB data sequentially from the base address of the DPB data buffer.

If storing the input data and the DPB data items, the processor 113 transmits an interrupt signal INTERRUPT H20 to the codec 112 (S1312). The processor 113 may transmit the interrupt signal INTERRUPT H20 whenever storing of an input data and a DPB data is completed or when storing of predetermined (or, alternatively, desired or selected) numbers of input data and DPB data is completed. The interrupt signal INTERRUPT H20 that is transmitted as storing of the predetermined (or, alternatively, desired or selected) numbers of input data and DPB data is completed may include the numbers of stored input data INPUT DATA 4 to INPUT DATA 7 and stored DPB data DPB DATA 4 to DPB DATA 7.

The codec 112 reads an input data INPUT DATA 4 from the input data buffer of the working memory 150 on the basis of the interrupt signal INTERRUPT H20 (S1313). The codec 112 may receive an address range of the input data buffer from the processor 113 before operation S1313. When receiving the interrupt signal INTERRUPT H20 for the first time, the codec 112 may read the input data INPUT DATA 4 from the base address of the input data buffer.

The codec 112 reads the DPB data DPB DATA 4 from the DPB data buffer of the working memory 150 on the basis of the interrupt signal INTERRUPT H20 (S1314). The codec 112 may receive an address range of the DPB data buffer from the processor 113 before operation S1313. When receiving the interrupt signal INTERRUPT H20 for the first time, the codec 112 may read the DPB data DPB DATA 4 from the base address of the DPB data buffer.

The codec 112 decodes an encoded bitstream ENCODED BITSTREAM 4 stored at an encoded bitstream buffer address with respect to the input data INPUT DATA 4 (S1315). Here, the encoded bitstream ENCODED BITSTREAM 4 may be an interlaced picture. For example, the encoded bitstream ENCODED BITSTREAM 4 may be a top field picture or a bottom field picture. The encoded bitstream ENCODED BITSTREAM 4 may include information on whether the decoded picture has been arranged according to the interlaced scan type and information whether the decoded picture is a top field picture or a bottom field picture, as information on the picture arrangement manner. The codec 112 may read the encoded bitstream ENCODED BITSTREAM 4 from the working memory 150 on the basis of the encoded bitstream buffer address included in the input data INPUT DATA 4, and decodes the encoded bitstream ENCODED BITSTREAM 4 to generate the top field data of the interlaced picture of one frame.

The codec 112 writes the decoded picture DECODED PICTURE 4 in a DPB with reference to the DPB data DPB DATA 4 (S1316). The codec 112 may write the decoded picture DECODED PICTURE 4 in the working memory 150 on the basis of the DPB address DPB ADDRESS 4 included in the DPB data DPB DATA 4.

The codec 112 writes an output data OUTPUT DATA 4 related to the decoded picture DECODED PICTURE 4 in the output data buffer (S1317). When completing decoding for the first time, the codec 112 may write the output data in a base address of the output data buffer. The output data OUTPUT DATA 4 may include information indicating that decoding of the top field of the interlaced picture has been completed.

When the writing of the output data is completed, the codec 112 transmits an interrupt signal INTERRUPT C4 to the processor 113 (S1318).

The processor 113 receives the interrupt signal INTERRUPT C4, and reads the output data OUTPUT DATA 4 from the output data buffer (S1319). The processor 113 may determine the address in the output data buffer where the output data OUTPUT DATA 4 has been stored, on the basis of the number of times the interrupt signal INTERRUPT C4 has been received. The processor 113 may read the output data OUTPUT DATA 4 from the determined address. The processor 113 may determine that a decoded picture DECODED PICTURE 4 is the top field data of the interlaced picture of one frame, from the output data OUTPUT DATA 4. Accordingly, the processor 113 may not transmit a control signal for displaying an interlaced picture of one frame to the display controller 115 after the output data OUTPUT DATA 4 is read until an output data (for example, an output data OUTPUT DATA 5) indicating that decoding of an interlaced picture of one frame has been completed is read.

If decoding of the interlaced picture has not been completed, the codec 112 reads the input data INPUT DATA 5 from the input data buffer of the working memory 150 (S1320).

The codec 112 decodes an encoded bitstream ENCODED BITSTREAM 5 stored at an encoded bitstream buffer address with respect to the input data INPUT DATA 5 (S1321). The codec 112 may generate the bottom field data of the interlaced picture of one frame.

The codec 112 writes a decoded picture DECODED PICTURE 5 in a DPB, on the basis of a DPB address DPB ADDRESS 4 where the top field data has been stored (S1322).

The codec 112 writes an output data OUTPUT DATA 5 related to the decoded picture DECODED PICTURE 5 in the output data buffer (S1323). The codec 112 may generate the output data OUTPUT DATA 5 including information indicating that decoding of the interlaced picture of one frame has been completed. The codec 112 may write the output data at the next address of the address of the output data buffer where the output data OUTPUT DATA 4 has been stored.

When the writing of the output data OUTPUT DATA 5 is completed, the codec 112 transmits an interrupt signal INTERRUPT C5 to the processor 113 (S1324).

The processor 113 receives the interrupt signal INTERRUPT C5, and reads the output data OUTPUT DATA 5 from the output data buffer (S1325). The processor 113 may determine the address in the output data buffer where the output data OUTPUT DATA 5 has been stored, on the basis of the number of times the interrupt signal INTERRUPT C5 has been received. The processor 113 may read the output data OUTPUT DATA 5 from the determined address.

The processor 113 transmits a control signal for displaying the decoded pictures DECODED PICTURE 4 and DECODED PICTURE 5 to the display controller 115 on the basis of the output data OUTPUT DATA 5 (S1326). The processor 113 may check out the information indicating that decoding of the interlaced picture of one frame of the output data OUTPUT DATA 5 has been completed, and generate a control signal for displaying the decoded pictures DECODED PICTURE 4 and DECODED PICTURE 5. The control signal may include the DPB address DPB ADDRESS 4 determined on the basis of the output data OUTPUT DATA 5.

The display controller 115 reads the decoded pictures DECODED PICTURE 4 and DECODED PICTURE 5 stored at the DPB address DPB ADDRESS 4 of the DPB (S1340).

The display controller 115 may display the decoded pictures DECODED PICTURE 4 and DECODED PICTURE 5 on the display 130 (S1340).

After transmitting the interrupt signal INTERRUPT C5, the codec 112 reads an input data INPUT DATA 6 from the input data buffer (S1328).

The codec 112 reads the DPB data DPB DATA 5 from the DPB data buffer of the working memory 150 on the basis of the interrupt signal INTERRUPT H20 (S1329).

The codec 112 decodes an encoded bitstream ENCODED BITSTREAM 6 stored at an encoded bitstream buffer address with respect to the input data INPUT DATA 6 (S1330).

The codec 112 writes a decoded picture DECODED PICTURE 6 in a DPB with reference to the DPB data DPB DATA 5 (S1331). The codec 112 may write the decoded picture DECODED PICTURE 6 in the working memory 150 on the basis of the DPB address DPB ADDRESS 5 included in the DPB data DPB DATA 5.

The codec 112 writes an output data OUTPUT DATA 6 related to the decoded picture DECODED PICTURE 6 in the output data buffer (S1332).

When the writing of the output data is completed, the codec 112 transmits an interrupt signal INTERRUPT C6 to the processor 113 (S1333).

The processor 113 receives the interrupt signal INTERRUPT C6, and reads the output data OUTPUT DATA 6 from the output data buffer (S1334).

The processor 113 transmits a control signal for displaying the decoded picture DECODED PICTURE 6 to the display controller 115 (S1335). The control signal may include a DPB address DPB ADDRESS 5 determined on the basis of the output data OUTPUT DATA 6.

The display controller 115 reads the decoded picture DECODED PICTURE 6 stored at the DPB address DPB ADDRESS 5 of the DPB (S1336).

The display controller 115 may display the decoded picture DECODED PICTURE 6 on the display 130 (S1337).

According to the method of using the working memory 150 described with reference to FIG. 5, the top field data and bottom field data of a bitstream encoded in the interlaced scan manner may be stored in different DPB areas, respectively. Accordingly, the bitstream encoded in the interlaced scan manner may be decoded using the SFR in the codec memory 210. In the case of using the SFR, while the codec 112 is decoding the encoded bitstream stored in the SFR, since the SFR is in use, the processor 113 cannot use a new encoded bitstream in the SFR. Further, while the processor 113 is processing a decoded picture, the codec 112 cannot perform a decoding operation until the processor 113 stores a new encoded bitstream in the SFR. Therefore, in the decoding method using the SFR, latency may occur.

According to some example embodiments, in the case of decoding a bitstream encoded in the interlaced scan manner, the codec 112 may store the top field data and the bottom field data in one DPB area. Therefore, according to some example embodiments, latency can be reduced as compared to the case of using the SFR.

For example, according to some example embodiments, there may be an increase in speed, accuracy, and/or power efficiency of the memory device based on the above decoding methods. Therefore, the improved devices and methods overcome the deficiencies of the conventional devices and methods of decoding data related to decoding/encoding image data while reducing resource consumption, data accuracy, and resource allocation (e.g., latency). Further, there is an improvement in communication and reliability in the device by providing the abilities disclosed herein, for example, related to DPB addresses and memory storage architecture.

In some example embodiments, each of the components described with reference to FIG. 1 to FIG. 13, or a combination of two or more components may be implemented as a digital circuit, a programmable or non-programmable logic device or array, an application specific integrated circuit (ASIC), etc.

As described herein, any electronic devices and/or portions thereof according to any of the example embodiments may include, may be included in, and/or may be implemented by one or more instances of processing circuitry such as hardware including logic circuits; a hardware/software combination such as a processor executing software; or any combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a DRAM device, storing a program of instructions, and a processor (e.g., CPU) configured to execute the program of instructions to implement the functionality and/or methods performed by some or all of any devices, systems, modules, units, controllers, circuits, architectures, and/or portions thereof according to any of the example embodiments, and/or any portions thereof.

While these inventions have been described in connection with what is presently considered to be practical example embodiments, it is to be understood that the inventions are not limited to the disclosed embodiments. On the contrary, it is intended to cover various modifications and equivalent arrangements included within the spirit and scope of the appended claims.

What is claimed is:

1. A decoding method comprising:
reading a first input data including information on a first encoded bitstream buffer address from an input data buffer;
reading a first DPB data including information on a first DPB address from a DPB data buffer;
generating a first decoded picture by decoding a first encoded bitstream stored at the first encoded bitstream buffer address; and
storing the first decoded picture at the first DPB address.

2. The decoding method of claim 1, further comprising:
determining whether a value of flag data of the first DPB data is a first value;
wherein the storing the first decoded picture at the first DPB address includes storing the first decoded picture at the first DPB address based on the value of the flag data of the first DPB data being the first value.

3. The decoding method of claim 2, further comprising:
changing the value of the flag data of the first DPB data to a second value based on storing the first decoded picture at the first DPB address.

4. The decoding method of claim 2, further comprising:
reading a second DPB data from the next address of the address of the DPB data buffer where the first DPB data has been stored, based on the value of the flag data of the first DPB data being a second value.

5. The decoding method of claim 1, further comprising:
reading second DPB data including information on a second DPB address from the DPB data buffer;
generating a second decoded picture by decoding the encoded bitstream; and
storing the second decoded picture at the second DPB address.

6. The decoding method of claim 5, wherein the reading the second DPB data includes reading the second DPB data from the next address of the address of the DPB data buffer where the first DPB data has been stored.

7. The decoding method of claim 5, further comprising:
reading a second input data including information on a second encoded bitstream buffer address from the input data buffer;
reading a third DPB data including information on a third DPB address from the DPB data buffer;
generating a third decoded picture by decoding a second encoded bitstream stored at the second encoded bitstream buffer address; and
storing the third decoded picture at the third DPB address.

8. The decoding method of claim 1, further comprising:
reading a second input data including information on a second encoded bitstream buffer address from the input data buffer;
generating a second decoded picture by decoding a second encoded bitstream stored at the second encoded bitstream buffer address; and
storing the second decoded picture at the first DPB address.

9. The decoding method of claim 8, wherein
the first decoded picture and the second decoded picture are top field data and bottom field data of an interlaced picture of one frame, respectively, and
the decoding method further includes writing an output data including information indicating that decoding of the interlaced picture of one frame has been completed, in an output data buffer.

10. The decoding method of claim 1, further comprising:
writing a second DPB data including information on a second DPB address in the DPB data buffer.

11. The decoding method of claim 10, wherein
the writing the second DPB data includes the following:
determining whether a value of flag data of the first DPB data is a second value; and
writing the second DPB data at the address where the first DPB data has been stored, based on the value of the flag data of the first DPB data being the second value.

12. A system-on-chip comprising:
a processor configured to
write a first input data including information on a first encoded bitstream buffer address in an input data buffer, and
write a first DPB data including information on a first DPB address in a DPB data buffer; and
a codec configured to
read the first input data from the input data buffer,
read the first DPB data from the DPB data buffer,
generate a first decoded picture by decoding a first encoded bitstream stored at the first encoded bitstream buffer address, and
store the first decoded picture at the first DPB address.

13. The system-on-chip of claim 12, wherein
the codec is further configured to determine whether a value of flag data of the first DPB data is a first value, store the first decoded picture at the first DPB address based on the value of the flag data of the first DPB data being the first value, and change the value of the flag data of the first DPB data to a second value based on storing the first decoded picture at the first DPB address.

14. The system-on-chip of claim 13, wherein
the codec is further configured to read the second DPB data from the next address of the address of the DPB data buffer where the first DPB data has been stored, based on the value of the flag data of the first DPB data being a second value.

15. The system-on-chip of claim 12, wherein
the processor is further configured to determine whether a value of flag data of the first DPB data is a second value, and write a second DPB data including information on a second DPB address at the address where the first DPB data has been stored, based on the value of the flag data of the first DPB data being the second value.

16. The system-on-chip of claim 12, wherein
the codec is further configured to read a second DPB data including information on a second DPB address from the DPB data buffer, generate a second decoded picture by decoding the encoded bitstream, and store the second encoded picture at the second DPB address.

17. The system-on-chip of claim 16, wherein
the codec is further configured to read a second input data including information on a second encoded bitstream buffer address from the input data buffer, read a third DPB data including information on a third DPB address from the DPB data buffer, generate a third decoded picture by decoding a second encoded bitstream stored at the second encoded bitstream buffer address, and store the third decoded picture at the third DPB address.

18. The system-on-chip of claim 12, wherein
the codec is further configured to read a second input data including information on a second encoded bitstream buffer address from the input data buffer, generate a second decoded picture by decoding a second encoded bitstream stored at the second encoded bitstream buffer address, and store the second decoded picture at the first DPB address.

19. A decoding device comprising:
a working memory including
an encoded bitstream buffer configured to store a plurality of encoded bitstreams,
an input data buffer configured to store a plurality of input data including information on a plurality of encoded bitstream buffer addresses,
a decoded picture buffer (DPB) configured to store a plurality of decoded pictures, and
a DPB data buffer configured to store a plurality of DPB data including information on a plurality of DPB addresses; and
a system-on-chip configured to
read a first input data including information on a first encoded bitstream buffer address from the input data buffer,
read a first DPB data including information on a first DPB address from the DPB data buffer,
read a first encoded bitstream stored at the first encoded bitstream buffer address,
generate a first decoded picture by decoding the first encoded bitstream, and
store the first decoded picture at the first DPB address of the decoded picture buffer.

20. The decoding device of claim 19, wherein
the plurality of DPB data further includes a plurality of flag data, and
the system-on-chip is further configured to use or update the plurality of DPB data on a basis of the plurality of flag data.
